(19) United States
(12) Patent Application Publication
(10) Pub. No.: US 2010/0323267 A1
(43) Pub. Date: Dec. 23, 2010

(54) Method for producing an electrically insulating sealing arrangement for a fuel cell stack and sealing arrangement for a fuel cell stack

(75) Inventors: Uwe Maier, Reutlingen (DE); Thomas Kiefer, Bad Urach (DE); Frank Tietz, Juelich (DE)

Correspondence Address: JORDAN AND HAMBURG LLP, 122 EAST 42ND STREET, SUITE 4000, NEW YORK, NY, 10168, US

(73) Assignee: Forschungszentrum Juelich GmbH, Juelich (DE)

(21) Appl. No.: 12/735,574

(22) PCT Filed: Feb. 2, 2008
(86) PCT No.: PCT/EP2008/000844

§ 371 Date: Jul. 29, 2010

(51) Int. Cl. H01M 8/02; H01M 2/08; H01M 8/24

(52) U.S. Cl. 429/469; 429/535

(57) ABSTRACT

In order to create a method for producing an electrically insulating sealing assembly for producing a seal between two components of a fuel cell stack, which allows for production of a sealing assembly that offers long-term stability during operation of a fuel cell system and provides good gas tightness and good electrical insulation properties, a method comprising the following steps is proposed: applying an insulating layer starting material onto a substrate in a wet-chemical process; heating the insulating layer starting material to a sinter temperature so as to produce a sintered, electrically insulating, ceramic insulating layer; and directly or indirectly joining the insulating layer to the components to be sealed.

The present invention relates to a method for producing an electrically insulating sealing assembly for producing a seal between two components of a fuel cell stack.

The production of suitable sealing systems is a focal area in the development of high-temperature fuel cell systems (referred to as SOFCs).

Such sealing systems must satisfy strict requirements in terms of gas tightness, electrical insulation, chemical stability, and tolerance with respect to mechanical stress (particularly during thermocycling).

The use of solder glass seals for sealing purposes in fuel cell systems is already known. Such solder glass seals exhibit good gas tightness, electrical insulation, and chemical resistance. The solder glass softens during the joining cycle before it crystallizes and hardens. The sealing gap of the solder glass seal can be adjusted by using ceramic spacers. Conventional thicknesses range around 300 μm+/−50 μm.

However, such solder glass seals exhibit only low tolerances with respect to mechanical stress during thermocycling, which is due to the poor thermal conductivity and the brittle behavior of the material.

The use of metallic brazing material seals for sealing purposes in fuel cell systems is also already known. Such metallic brazing material seals have advantages in terms of the ductile behavior thereof, particularly during thermocycling. Metallic brazing materials, however, are not suitable as electrical insulators, so that an additional insulating layer is required. It is known, for example, to use an aluminum magnesium spinel layer, produced by way of vacuum plasma spraying, as the insulating layer.

Producing such an insulating layer by way of vacuum plasma spraying, however, is a complex and expensive process step. Given the manufacturing tolerances, appropriately high safety factors must be selected, resulting in a thick insulating layer, which is associated with increased material consumption. In addition, a thicker aluminum magnesium spinel insulating layer, which has a different thermal coefficient of expansion from the steel materials used in the fuel cell stack, induces residual stress. This residual stress may cause cracks and consequently leaks in the fuel cell system.

It is the object of the present invention to create a method for producing an electrically insulating sealing assembly for producing a seal between two components of a fuel cell stack, allowing for the production of a sealing assembly that offers long-term stability during the operation of a fuel cell system and provides good gas tightness and good electrical insulation properties.

This object is achieved according to the invention by a method for producing an electrically insulating sealing assembly for producing a seal between two components of a fuel cell stack, comprising the following steps:
applying an insulating layer starting material onto a substrate in a wet-chemical process;
heating the insulating layer starting material to a sinter temperature to produce a sintered, electrically insulating, ceramic insulating layer; and
directly or indirectly joining the insulating layer to the components to be sealed.

Joining of the insulating layer to the components to be sealed can be carried out simultaneously with the production of the insulating layer, or after the insulating layer has been produced.

The substrate, onto which the insulating layer starting material is applied in a wet-chemical process, can be one of the components to be sealed or another element of the fuel cell stack.

The insulating layer preferably has an electrical surface resistivity of at least 1 kΩ·cm², and in particular at least 5 kΩ·cm², at the operating temperature of the fuel cell stack (in the range of 600° C. to 800° C.).

The underlying concept of the invention is to compress elements or compounds resulting therefrom (such as oxides or oxide mixtures) through a suitable sintering process by using cost-effective wet-chemical solutions (such as screen printing methods or application by way of a dispenser).

A particularly tight insulating layer can be produced by liquid phase sintering.

During liquid phase sintering, at least one component to be sintered forms at least a low melt portion. This melt portion acts as an adhesive for the particles to be sintered.

As an alternative, the insulating layer may also be produced by reactive sintering.

During reactive sintering, the components to be sintered react exothermically with each other, resulting in a local temperature increase.

It is particularly advantageous for the insulating layer starting material to comprise MgO. By adding MgO, the thermal coefficient of expansion of the insulating layer can be adapted to the thermal coefficient of expansion of other elements of the fuel cell stack, in particular to the thermal coefficient of expansion of the components to be sealed.

With a view to the highest possible insulation resistance and a thermal coefficient of expansion that is adapted to the other components of the fuel cell stack, it is also advantageous for the insulating layer starting material to comprise yttria-stabilized or lanthanide-stabilized (from La to Lu) zirconia, alumina, an Mg—Al-spinel and/or barium silicate.

In a preferred embodiment of the method according to the invention, the insulating layer starting material further comprises an additive serving to lower the melting temperature of the insulating layer.

Such an additive can be, in particular, a borate or phosphate.

It is therefore advantageous, for example, for the insulating layer starting material to comprise Li₂O—B₂O₃ and/or NbO₅—B₂O₃.

In order to lower the melting temperature of the insulating layer, it is also advantageous for the insulating layer starting material to comprise phosphate.

The insulating layer can be fixed to the components to be sealed at the same time as they are produced.

As an alternative, it may be provided that, after producing the insulating layer, this is brazed to at least one of the components to be sealed.

It is particularly advantageous for the insulating layer to be brazed to at least one of the components to be sealed by way of a metallic brazing material. Such a metallic brazing material has high ductility, whereby shearing forces occurring during the thermocycling of the fuel cell stack can be compensated for by the ductile behavior of the metallic brazing material.

According to a particularly preferred embodiment of the invention, the insulating layer is fixed to an intermediate element, which is different from the components to be sealed.

Such an intermediate element can notably be used to separate the insulating layer from a brazing material layer of the sealing assembly, thereby preventing brazing material from reacting with the material of the insulating layer, which could result in reduction of the electrical insulation effect of the insulating layer and/or embrittlement of the composite comprising the insulating layer and the brazing material layer.

It may be provided that the insulating layer is joined to the intermediate element at the same time as the layer is produced.

In a preferred embodiment of the invention, the intermediate element comprises a metallic material.

The intermediate element can in particular be made of the same metallic material as one of the components to be sealed.

The intermediate element is preferably fixed to one of the components to be sealed.

In particular, it may be provided that the intermediate element is brazed to one of the components to be sealed.

It is particularly advantageous for the intermediate element to be brazed to one of the components to be sealed by way of a metallic brazing material. The use of a metallic brazing material offers the advantage that shearing forces occurring during thermocycling can be compensated for by the ductile behavior of the metallic brazing material.

The present invention further relates to a sealing assembly for producing a seal between two components of a fuel cell stack.

It is a further object of the present invention to create such a sealing assembly, which offers long-term stability during the operation of the fuel cell stack and ensures good gas tightness and good electrical insulation.

This object is achieved according to the invention by a sealing assembly for producing a seal between two components of a fuel cell stack, comprising the following:
two components to be sealed; and
an electrically insulating, ceramic insulating layer which is disposed between the two components to be sealed, wherein the insulating layer is produced by applying an insulating layer starting material onto a substrate in a wet-chemical process and subsequently heating the insulating layer starting material to a sinter temperature.

To this end, the substrate may be one of the components to be sealed or another element of the fuel cell stack.

It is particularly advantageous for the electrically insulating ceramic insulating layer to be the only electrically insulating layer of the sealing assembly at the operating temperature of the fuel cell stack (in the range of 600° C. to 800° C.).

Special embodiments of the sealing assembly according to the invention are the subject matter of claims 23 to 42, the characteristics and advantages of which have already been described above in connection with the special embodiments of the method according to the invention.

Additional characteristics and advantages of the invention will be apparent from the following description and the illustrations of exemplary embodiments.

In the drawings:

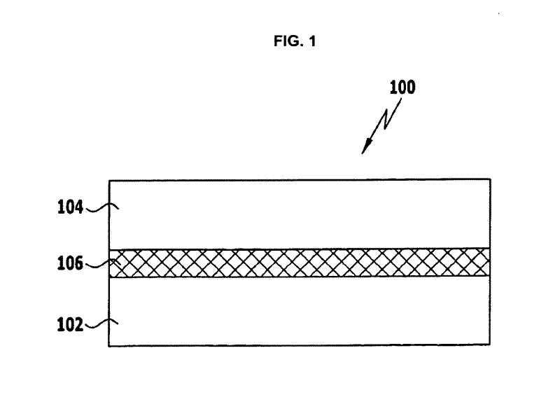

FIG. 1 is a schematic illustration of a sealing assembly for a fuel cell unit, which comprises two components to be sealed and an interposed insulating layer;

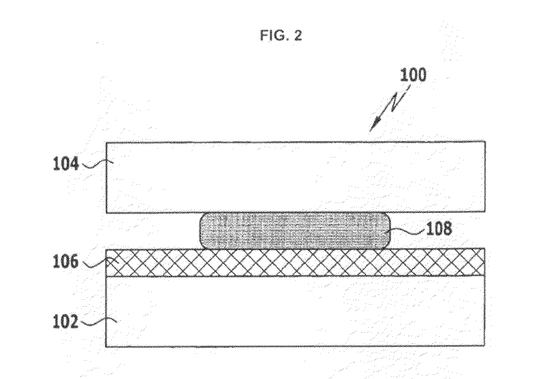

FIG. 2 is a schematic sectional view of a second embodiment of a sealing assembly which, in addition to the two components to be sealed and the insulating layer, comprises a brazing material layer joining the insulating layer to the second component; and

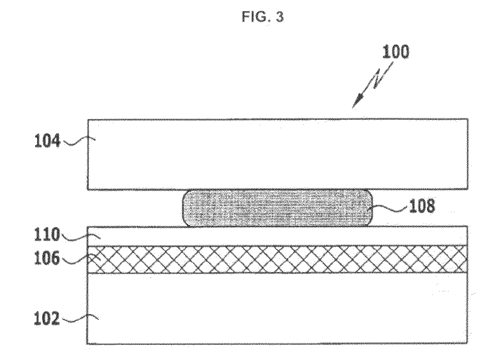

FIG. 3 is a schematic sectional view of a third embodiment of a sealing assembly which, in addition to the two components to be sealed and the insulating layer, comprises an intermediate element fixed to the insulating layer and a brazing material layer joining the intermediate element to one of the components to be sealed.

Identical or functionally equivalent elements are denoted in all figures with the same reference numerals.

A method for producing the first embodiment of a sealing assembly, which is illustrated in FIG. 1 and denoted in the overall by numeral 100, for producing a seal between a metallic first component 102 and a metallic second component 104 of a fuel cell stack by way of an electrically insulating, ceramic insulating layer 106 disposed between the components 104 and 102 comprises the following steps:
applying an insulating layer starting material onto the first component 102 in a wet-chemical process;
bringing the second component 104 in contact with the coating comprising the insulating layer starting material; and
heating the two components 102 and 104 and the interposed coating comprising the insulating layer starting material to a sinter temperature so as to create the sintered, electrically insulating, ceramic insulating layer 106, which is sintered directly onto the two components 102 and 104, and thereby joining the two components 102 and 104 to each other.

The first component 102 can be an upper housing part of a housing of a fuel cell unit, for example, and the second component 104 can be a lower housing part of a further fuel cell unit following the first fuel cell unit in a stacking direction of a fuel cell stack.

Such fuel cell units having two-part housings, which are composed of a lower housing part and an upper housing part, are disclosed in DE 103 58 458 A1, for example, which is hereby referenced and included in this application by reference.

The first component 102 and/or the second component 104 can, in particular, be used as the bipolar plate or interconnector in the respective fuel cell unit.

Both components 102 and 104 may, in particular, comprise steel forming chromium oxide.

The two components 102 and 104 are made, for example, of a ferritic, chromium oxide-forming stainless steel, such as the stainless steel Crofer 22 APU, which has the following composition:

22.2 percent by weight Cr; 0.46 percent by weight Mn; 0.06 percent by weight Ti; 0.07 percent by weight La; 0.002 percent by weight C; 0.02 percent by weight Al; 0.03 percent by weight Si; 0.004 percent by weight N; 0.02 percent by weight Ni; the remainder being iron.

A suspension having the following composition is sprayed onto a free surface of the metallic first component 102, for example by way of a wet spray method: 1 part by weight of a ceramic powder; 1.5 parts by weight ethanol; 0.04 parts by weight of a dispersing agent (such as Dolapix ET 85); and 0.1 parts by weight of a binding agent (such as polyvinyl acetate, PVAC).

The ceramic powder for the suspension is produced as follows:

First, a quantity of the base material and at least one filler material in the form of oxides, silicates and/or phosphates are weighed in the desired proportion.

The following can be used as the base material:
LnSZ comprising 3 to 50 mol % Ln₂O₃ and Ln=Y or one of the lanthanides from La to Lu, where LnSZ denotes Ln-stabilized zirconia; this includes in particular pyrochlores having the composition Ln₂Zr₂O₇ or 3YSZ (zirconia stabilized with 3 mol Y), 8YSZ (zirconia stabilized with 8 mol Y) or 10YSZ (zirconia stabilized with 10 mol Y);
titanates, in particular magnesium titanate, such as MgTiO₃ or Mg₂TiO₄;
MgAl₂O₄ (magnesium aluminum spinel); and
barium silicates.

All base materials, and in particular those mentioned above, may comprise additional MgO.

By adding MgO, in a range of 0 to 100% by volume, the thermal coefficient of expansion of the insulating layer that is to be produced can be adapted to a desired value, and preferably to the value of the thermal coefficient of expansion of the material of the two components 102 and 104.

A base material having the composition MgAl₂O₄—MgO (volume ratio 10:90), for example, has a thermal coefficient of expansion of 12.6·10⁻⁶K⁻¹.

A base material having the composition YSZ—MgO (volume ratio 10:90), for example, has a thermal coefficient of expansion of 12.3·10⁻⁶K⁻¹.

The base material that is used may also be composed of a combination of YSZ, MgAl₂O₄ and/or barium silicates, optionally with the addition of MgO.

In particular the following materials can be used as the filler materials:
borates, in particular those having a melting point that is at least 50° C. above the operating temperature of the fuel cell, such as Li₂O—B₂O₃ or NbO₅—B₂O₃; and
phosphates, in particular those having a melting point that is at least 50° C. above the operating temperature of the fuel cell.

The operating temperature of the fuel cell preferably ranges between 600° C. and 800° C.

By adding such filler materials, the melting temperature of the insulating layer to be produced can be lowered to a temperature below 1000° C., thereby enabling sintering in liquid phases.

The filler materials can be mixed with the respective base material at a volume ratio of 0 to 100%.

It is also possible to mix a combination of a plurality of the above filler materials with one of the base materials mentioned above.

In a preferred embodiment, a ceramic powder comprising 3YSZ and MgO at a volume ratio of 80:20 is used as the base material. This base material is mixed with additional Li₂O—B₂O₃ (weight ratio 2:8) as the filler material, the proportion of the filler material in the total ceramic powder amounting to from approximately 4 percent by weight to approximately 12 percent by weight.

The thermal coefficient of expansion of the insulating layer produced from this is approximately 12·10⁻⁶K⁻¹.

A polyethylene bottle is filled with the weighed powder comprising the base material and filler materials together with ethanol and ZrO₂ grinding balls (having an average diameter of approximately 3 mm).

The weight ratio for the powder:ethanol:grinding balls is approximately 1:2:3.

The polyethylene bottle is closed tightly and rotated for 48 hours on a roller bed.

The rotating speed of the bottle is, for example, 250 rpm.

After the rotating period, the grain size of the powder should be d₉₀=1 μm.

If the aforementioned grinding time of 48 hours is not sufficient, the grinding time should to be appropriately extended.

A grain size of d₉₀=1 μm means that 90 percent by weight of the particles of the ceramic powder have a grain size of no more than 1 mm.

After the desired ceramic powder grain size has been reached, the ZrO₂ grinding balls are removed from the mixture and the ceramic powder is dried.

The ceramic powder is not calcined.

Subsequently, the ceramic powder obtained in this way is mixed with ethanol, dispersing agent and binding agent, so as to produce the suspension having the aforementioned composition.

The suspension obtained in this way is sprayed onto the first component 102 serving as the substrate by way of the wet spray method using a spray nozzle.

The diameter of the nozzle opening which is used to atomize the suspension is approximately 0.5 mm.

The spray pressure with which the suspension is, for example, pumped to the nozzle is 0.3 bar.

The spray distance of the nozzle from the substrate is, for example, 15 cm.

The nozzle is moved over the substrate at a speed of 230 mm/s, for example.

The layer of the insulating layer starting material is applied onto the substrate in two to four coating cycles, which is to say by spraying each surface region of the substrate two to four times.

As an alternative to the wet spray method described above, it is also possible to employ a screen printing method in order to apply the ceramic powder onto the substrate.

For such a screen printing method a paste is produced, which, for example, comprises 50 percent by weight of the ceramic powder, 47 percent by weight of terpineol, and 3 percent by weight of ethyl cellulose.

The ceramic powder is produced in the same manner as was described above in connection with the wet spray method.

In order to shorten the grinding duration that is required, it is also possible to add 2 to 4 percent by weight (relative to the weight of the ceramic powder) of a dispersing agent (such as Dolapix ET 85) in order to achieve the stated grain size.

The constituents of the paste are homogenized in a cylinder mill.

Thereafter, the paste comprising the insulating layer starting material is applied onto the first component 102 serving as the substrate using a screen printing system, which is known per se to persons skilled in the art.

The second component 104 is brought in contact with the layer comprising the insulating layer starting material on the side facing away from the first component 102, and subsequently the assembly composed of the two components 102 and 104 and the interposed layer comprising the insulating layer starting material is placed in a sintering furnace.

The sintering furnace is heated, so that the components 102 and 104 and the layer comprising the insulating layer starting material are heated to a sinter temperature of approximately 1050° C., for example.

The components 102 and 104 and the layer comprising the insulating layer starting material are maintained at this sinter temperature for a holding period of approximately 5 hours, whereby the layer comprising the insulating layer starting material is sintered and the insulating layer 106 is produced therefrom.

Heating to the sinter temperature can be carried out, for example, at a heating rate of 3 K/min.

After the holding period has expired, the sealing assembly composed of the two components 102 and 104 and the interposed insulating layer, which joins the two components 102 and 104 in a manner that is sealing and electrically insulating, is cooled to ambient temperature in an uncontrolled manner.

The first embodiment of a sealing assembly illustrated in FIG. 1, in which the two components 102 and 104 are joined at the same time as the insulating layer 106 is produced, offers the advantage of cost-effective production.

However, in some cases, this embodiment can absorb only low shearing forces during the thermocycling of the fuel cell stack.

A second embodiment of the sealing assembly 100 illustrated in FIG. 2 differs from the first embodiment illustrated in FIG. 1 in that the insulating layer 106, which is configured on the first component 102, is not fixed directly to the second component 104, but is joined to the second component 104 by way of a brazing material layer 108.

This embodiment offers the advantage that shearing forces occurring during thermocycling can be compensated for by the ductile behavior of the metallic brazing material of the brazing material layer 108.

The procedure for producing the sealing assembly 100 according to the second embodiment illustrated in FIG. 2 is as follows:

First, a coating comprising the insulating layer starting material is applied onto the first component 102 by a wet-chemical process.

The component 102 having the layer comprising the insulating layer starting material disposed thereon is heated in a sintering furnace to a sinter temperature, whereby the insulating layer 106 is produced by sintering the insulating layer starting material.

After sintering the insulating layer 106, a metallic brazing material is applied onto the free surface of the insulating layer 106 and/or onto a free surface of the second component 104.

Subsequently, the metallic second component 104 is brazed with the insulating layer 106 to the metallic first component 102 using the brazing material liquefied during brazing, while applying a contact pressure.

Suitable metallic brazing materials with which to produce the brazing material layer 108 are, for example, nickel-based brazing materials, copper-based brazing materials, or silver-based brazing materials.

Suitable brazing materials notably include the following:
the nickel-based brazing material having the designation Ni 102 according to DIN EN 1044, having the following composition: 7 percent by weight Cr; 4.5 percent by weight Si; 3.1 percent by weight B; 3.0 percent by weight Fe; less than 0.06 percent by weight C; less than 0.02 percent by weight P; the remainder being Ni.
the copper-based brazing material having the designation CU 202 according to DIN EN 1044, having the following composition: 12 percent by weight Sn; 0.2 percent by weight P; the remainder being Cu.
the silver-based brazing material having the designation Ag4CuO, distributed by Innobraze GmbH, Germany, under the product number PA 9999999, having the following composition: 96 mol % Ag; 4 mol % CuO.

In terms of design, function and production method, the sealing assembly embodiment illustrated in FIG. 2 otherwise conforms to the first embodiment illustrated in FIG. 1, the forgoing description of which is hereby referenced.

In the second embodiment of a sealing assembly illustrated in FIG. 2, the metallic brazing material of the brazing material layer 108 may, in some cases, react with the material of the insulating layer 106, as a result of which the electric insulating effect of the insulating layer 106 is lost and/or the composite including the insulating layer 106 and the brazing material layer 108 is embrittled and is no longer able to compensate for any shearing forces.

A third embodiment of the sealing assembly 100 illustrated in FIG. 3 differs from the second embodiment illustrated in FIG. 2 in that the insulating layer 106 does not directly adjoin the brazing material layer 108, but instead an intermediate element 110 is disposed between the insulating layer 106 and the brazing material layer 108.

The intermediate element 110 is preferably made of a metallic material, and in particular a steel material.

The intermediate element 110 can, in particular, be made of the same steel material as the first component 102 and/or the second component 104.

Because the insulating layer 106 is separated from the brazing material layer 108 by the intermediate element 110, in the third embodiment of the sealing assembly 100, no disadvantageous interactions can take place between the metallic brazing material of the brazing material layer 108 and the material of the insulating layer 106.

In particular no brittle phases can be created as a result of the reaction of the metallic brazing material with the material of the insulating layer 106. The ductility of the metallic brazing material of the brazing material layer 108 is thus definitely preserved in this embodiment and can compensate for shearing forces that occur during the thermocycling of the fuel cell stacks.

The procedure for producing the third embodiment of the sealing assembly 100 according to FIG. 3 is as follows:

A coating comprising the insulating layer starting material is applied onto the metallic first component 102 in a wet-chemical process.

The metallic intermediate element 110 is brought in contact with the free surface of the coating comprising the insulating layer starting material.

The first component 102, the intermediate element 110, and the interposed layer comprising the insulating layer starting material are placed in a sintering furnace and heated to a sinter temperature, so that the insulating layer 106, which joins the intermediate element 110 to the first component 102 in an electrically insulating manner, is produced from the insulating layer starting material by sintering.

The production of the composite including the first component 102, the insulating layer 106, and the intermediate element 110 thus substantially corresponds to the production of the composite including the first component 102, the insulating layer 106, and the second component 104 in the first embodiment of the sealing assembly 100.

Subsequently, a metallic brazing material is applied onto the free surface of the intermediate element 110 and/or onto a free surface of the metallic second component 104, and the metallic second component 104 is brazed to the intermediate element 110 using the brazing material liquefied during brazing, while applying a contact pressure.

The brazing material used can be the same brazing materials as described above in connection with the production of the second embodiment of the sealing assembly 100.

1. A method for producing an electrically insulating sealing assembly for producing a seal between two components of a fuel cell stack, comprising the following steps:
applying an insulating layer starting material onto a substrate in a wet-chemical process;
heating the insulating layer starting material to a sinter temperature to produce a sintered, electrically insulating, ceramic insulating layer; and
directly or indirectly joining the insulating layer to the components to be sealed;
wherein the insulating layer is brazed to at least one of the components to be sealed by way of a metallic brazing material.

2. The method according to claim 1, wherein the insulating layer is produced by liquid phase sintering.

3. The method according to claim 1, wherein the insulating layer is produced by reactive sintering.

4. A method according to claim 1, wherein the insulating layer starting material comprises MgO.

5. A method according to claim 1, wherein the insulating layer starting material comprises an yttria-stabilized or lanthanide-stabilized zirconia.

6. A method according to claim 1, wherein the insulating layer starting material comprises alumina.

7. A method according to claim 1, wherein the insulating layer starting material comprises a Mg—Al-spinel.

8. A method according to claim 1, wherein the insulating layer starting material comprises barium silicate.

9. A method according to claim 1, wherein the insulating layer starting material comprises an additive serving to lower the melting temperature of the insulating layer.

10. A method according to claim 1, wherein the insulating layer starting material comprises a borate.

11. The method according to claim 10, wherein the insulating layer starting material comprises Li₂O—B₂O₃ or NbO₅—B₂O₃.

12. A method according to claim 1, wherein the insulating layer starting material comprises a phosphate.

13. A method according to claim 1, wherein the insulating layer is fixed to the components to be sealed during the production of the layer.

14. A method according to claim 1, wherein the insulating layer is brazed to at least one of the components to be sealed after the production of the layer.

15. (canceled)

16. A method according to claim 1, wherein the insulating layer is fixed to an intermediate element which is different from the components to be sealed.

17. The method according to claim 16, wherein the insulating layer is joined to the intermediate element during the production of the layer.

18. The method according to claim 16, wherein the intermediate element comprises a metallic material.

19. A method according to claim 16, wherein the intermediate element is fixed to one of the components to be sealed.

20. The method according to claim 19, wherein the intermediate element is brazed to one of the components to be sealed.

21. The method according to claim 20, wherein the intermediate element is brazed to one of the components to be sealed by way of a metallic brazing material.

22. A sealing assembly for producing a seal between two components of a fuel cell stack, comprising two components to be sealed, and an electrically insulating, ceramic insulating layer disposed between the two components to be sealed, the insulating layer is produced by applying an insulating layer starting material onto a substrate in a wet-chemical process and subsequently heating the insulating layer starting material to a sinter temperature, and that that the insulating layer is brazed to at least one of the components to be sealed by way of a metallic brazing material.

23. The sealing assembly according to claim 22, wherein the insulating layer is produced by liquid phase sintering.

24. The sealing assembly according to claim 22, wherein the insulating layer is produced by reactive sintering.

25. A sealing assembly according to claim 22, wherein the insulating layer comprises MgO.

26. A sealing assembly according to claim 22, wherein the insulating layer comprises yttria-stabilized or lanthanide-stabilized zirconia.

27. A sealing assembly according to claim 22, wherein the insulating layer comprises alumina.

28. A sealing assembly according to claim 22, wherein the insulating layer comprises a Mg—Al spinel.

29. A sealing assembly according to claim 22, wherein the insulating layer (106) comprises barium silicate.

30. A sealing assembly according to claim 22, wherein the insulating layer comprises an additive serving to lower the melting temperature of the insulating layer.

31. A sealing assembly according to claim 22, wherein the insulating layer comprises a borate.

32. A sealing assembly according to claim 22, wherein the insulating layer comprises Li₂O—B₂O₃ or NbO₅—B₂O₃.

33. A sealing assembly according to claim 22, wherein the insulating layer comprises a phosphate.

34. A sealing assembly according to claim 22, wherein the insulating layer is sintered to the components to be sealed.

35. A sealing assembly according to claim 22, wherein the insulating layer is brazed to at least one of the components to be sealed.

36. (canceled)

37. A sealing assembly according to claim 22, wherein the sealing assembly comprises an intermediate element which is different from the components to be sealed and from the insulating layer.

38. A sealing assembly according to claim 37, wherein the insulating layer is sintered to the intermediate element.

39. The sealing assembly according to claim 37, wherein the intermediate element comprises a metallic material.

40. A sealing assembly according to claim 37, wherein the intermediate element is fixed to one of the components to be sealed.

41. The sealing assembly according to claim 40, wherein the intermediate element is brazed to one of the components to be sealed.

42. The sealing assembly according to claim 41, wherein the intermediate element is brazed to one of the components to be sealed by way of a metallic brazing material.
